(19) United States
(12) Patent Application Publication
(10) Pub. No.: US 2004/0051717 A1
(43) Pub. Date: Mar. 18, 2004

(54) Display unit

(75) Inventor: Takashi Naiki, Kyoto-shi (JP)

Correspondence Address: MERCHANT & GOULD PC, P.O. BOX 2903, MINNEAPOLIS, MN, 55402-0903, US

(73) Assignee: Rohm Co., Ltd, Kyoto-shi (JP)

(21) Appl. No.: 10/639,869

(22) Filed: Aug. 13, 2003

(30) Foreign Application Priority Data
Aug. 22, 2002 (JP) 2002-241446

(51) Int. Cl. G09G 5/02

(52) U.S. Cl. 345/596

(57) ABSTRACT

The input image data of a plurality of n bits input from the outside via the interface means is converted into a plurality of m (m<n) bits and output so that the data can be stored in the display memory means. Therefore, by the image conversion means, a dither signal corresponding to a position, at which the input image data is designated by a line and row on the display memory means, is generated, and the thus generated dither signal is added to the input image data, and the upper m bits of the image data, to which the dither signal is added, is output. Therefore, it is possible to provide a display unit in which image conversion by the dither method can be processed in real time according to a transmission stream of image data input from the outside without increasing a processing load given to MPU.

### BACKGROUND OF THE INVENTION

1. Field of the Invention

The present invention relates to a display unit using display elements such as liquid crystal display elements and organic EL display elements, particularly, to a display unit for reducing the number of bits of the image data input from the outside to write into the display memory.

2. Description of the Related Art

Recently, a display capability of display means such as a liquid crystal display system and an organic EL display system has been enhanced. Display means of a small apparatus such as PDA and cellular phone come to have high resolution and multiple-step gradations (for example, monochrome gradations, the number of color). Therefore, capacities of a display memory mounted on a display unit is increased as a matter of course, which causes the manufacturing cost of the display unit to increase.

On the other hand, the dither method and the error diffusion method and the like are conventionally known as a pseudo-method of increasing the number of gradations without increasing the length of a bit per one pixel of the display memory. In order to realize the above method, according to the conventional display unit, the original image data is processed by MPU or the like based on the dither method before image data is written in the display memory. In this way, the length of bits of the original image data is reduced and converted into the bit length of the display memory, then written in the display memory.

According to the conventional display unit described above, it is possible to suppress an increase in the size of the display memory by reducing the bit length of the original image data. However, a load given to MPU is additionally increased for the image processing. In the case that a load given to MPU is heavy, for example, when a process such as displaying images while arbitrary movie data is being downloaded with a cellular phone is performed, the processing ability may be seriously important because the image conversion processing is additionally performed.

### SUMMARY OF THE INVENTION

An object of the present invention is to provide a display unit in which image conversion by the dither method can be processed image data input from the outside in real time, as a transmission stream is, without increasing a processing load given to MPU.

The invention provides a display unit has display means; display memory means, which is connected to the display means, for storing a content to be displayed; driving means connected to the display means; image converting means for converting input image data of plural n bits, which are input from an outside via interface means, into image data of plural m (m<n) bits so as to store the image data of plural m bits in the display memory means; and a controller section for controlling at least one of the display means, the display memory means, the driving means and the image converting means, wherein the image converting means generates a dither signal or a random signal corresponding to a position of the input image data which is designated by a line and a row on the display memory means, adds the dither signal or the random signal to the input image data, and outputs upper m bits of the image data, to which the dither signal or the random signal was added.

The invention provides a display unit having a display memory for storing image data for displaying images on a display; and a dither signal generator for generating a dither signal, an adder for adding the dither signal to an input image data, and a memory controller for deleting predetermined lower bits from the input image data, to which the dither signal is added, to store a left input image data, which remains after deleting the predetermined lower bits, in the display memory.

Furthermore, the dither signal is systematic dither signal corresponding to a position of an input image data which is designated by a line and a row on the display memory.

Furthermore, the dither signal is random signal of 1 bit.

The invention provides a gradation reducing method having the steps of: generating a dither signal; adding the dither signal to an input image data; deleting predetermined lower bits from the input image data, to which the dither signal is added; and storing a left input image data, which remains after deleting the predetermined lower bits, in the display memory.

Furthermore, the dither signal is systematic dither signal corresponding to a position of an input image data which is designated by a line and a row on the display memory.

Furthermore, the dither signal is random signal of 1 bit.

According to the display unit in this invention, a systematic dither signal (that is, a dither matrix) and a random dither signal are added to the input image data of plural n bits, and the upper m bits are stored in the display memory. Therefore, image conversion by the dither method can be performed in real time, as a transmission stream of image data input from the outside, without increasing a processing load of MPU provided outside the interface means.

### BRIEF DESCRIPTION OF THE DRAWINGS

FIG. 1 is a view showing an arrangement of the liquid crystal driving device of the present invention;

FIG. 2 is a block diagram of the image conversion circuit of first embodiment of the present invention;

FIG. 3 is a view showing an example of the arrangement of the dither matrix 12;

FIGS. 4A to 4C are views showing a model of the order by which pixel data is processed; and

FIG. 5 is a block diagram of the image conversion circuit of second embodiment of the present invention;

FIG. 6 is a flowchart of function of the image conversion circuit of first embodiment of the present invention.

### DETAILED DESCRIPTION OF THE PREFERRED EMBODIMENTS

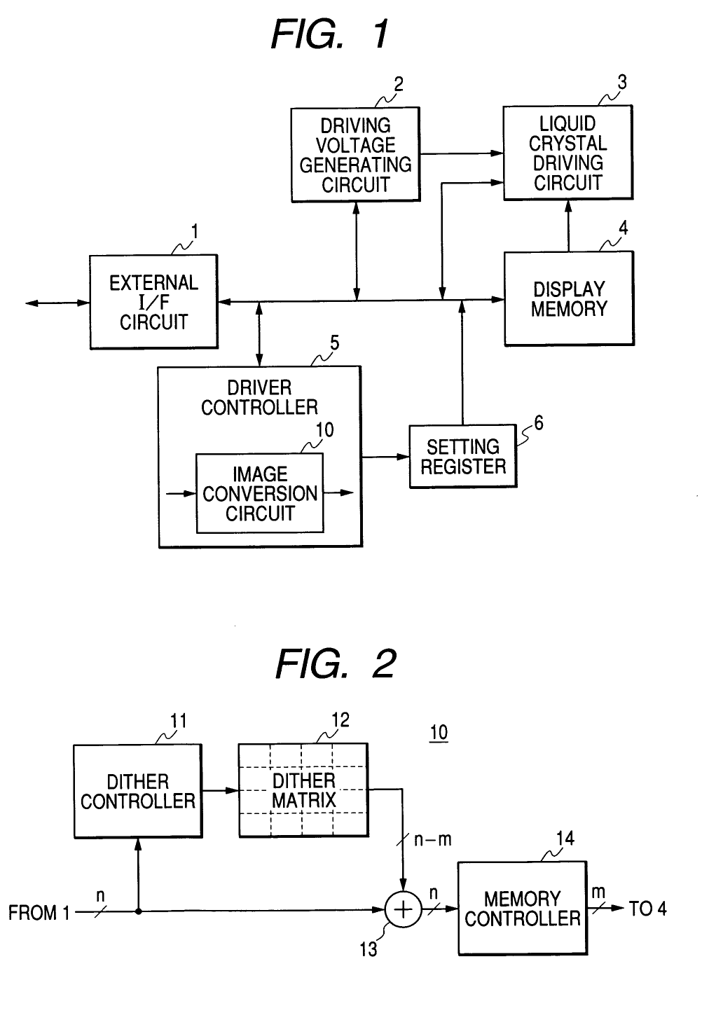

Referring to FIGS. 1 to 5, a liquid crystal display unit, which is an embodiment of the display unit of the present invention, will be explained as follows.

FIG. 1 is a view showing an arrangement of a liquid crystal driving device provided in a liquid crystal display unit of the present invention. This liquid crystal driving device mainly has the following modules, that is, an external I/F circuit 1, a driving voltage generating circuit 2, a liquid crystal driving circuit 3 configuring driving means together with the liquid crystal generating circuit 2, a display memory 4, a driver controller 5, a setting register 6, and an image conversion circuit 10. The image conversion circuit 10 is built in the driver controller 5, however, the image conversion circuit 10 may be separately arranged by itself. The image conversion circuit 10 further includes necessary components such as a timing generation circuit and the like which are not shown in the drawing.

The external I/F circuit 1 as interface means is an interface with a control unit such as MPU provided outside the liquid crystal driving device. The liquid crystal driving circuit 3 is applied a driving voltage from the driving voltage generating circuit 2 and receives a display data stored in the display memory 4 constituted by RAM, for example, then drives a liquid crystal display panel (not shown) as display means.

The setting register 6 is a register for storing various setting values of the liquid crystal driving device, for example, output voltage of a driver, display mode and frame frequency. According to these setting values, a condition of operating each component is set.

The image conversion circuit 10 in the liquid crystal driving device performs an image conversion. The image conversion is not performed by MPU (not shown) provided outside the liquid crystal driving device. The image conversion is different from the conventional processing by the MPU, that is, the addition of dither signal to input image data and the processing of deleting lower bits are performed in real time for a transmission bit stream.

Therefore, the image conversion circuit 10 prepares a dither matrix for converting bits (n bits→m bits; m<n), generates a dither signal corresponding to a position where the input image data is designated by a line and a row on the display memory 4, and adds the generated dither signal to the input image data. The image conversion circuit 10 deletes lower (n−m) bits of the image data, to which the dither signal is added, and outputs upper m bits. That is, the image conversion circuit 10 converts the input image data input via the external I/F circuit 1 from n bits to m bits and outputs the m bits image data to store in the display memory 4.

The driver controller 5 controls each component of the liquid crystal driving device and stores initial setting data sent from the external MPU in the setting register 6. In this embodiment, the driver controller 5 includes the image conversion circuit 10 described before.

FIG. 2 is a block diagram showing the image conversion circuit 10 of first embodiment. The image conversion circuit 10 shown in FIG. 2 uses dither matrix for dither processing.

A dither controller 11 provides a control signal, which corresponds to a line and a row of the display memory 4 storing the input image data supplied via the external I/F circuit 1, to a dither matrix 12. The control signal is determined according to an image plane writing start timing signal supplied from the outside together with the input image data, or an X address and a Y address showing a pixel position and the like. It is possible to completely synchronize the dither signal, which is read out from the dither matrix according to the control signal, with the input image data.

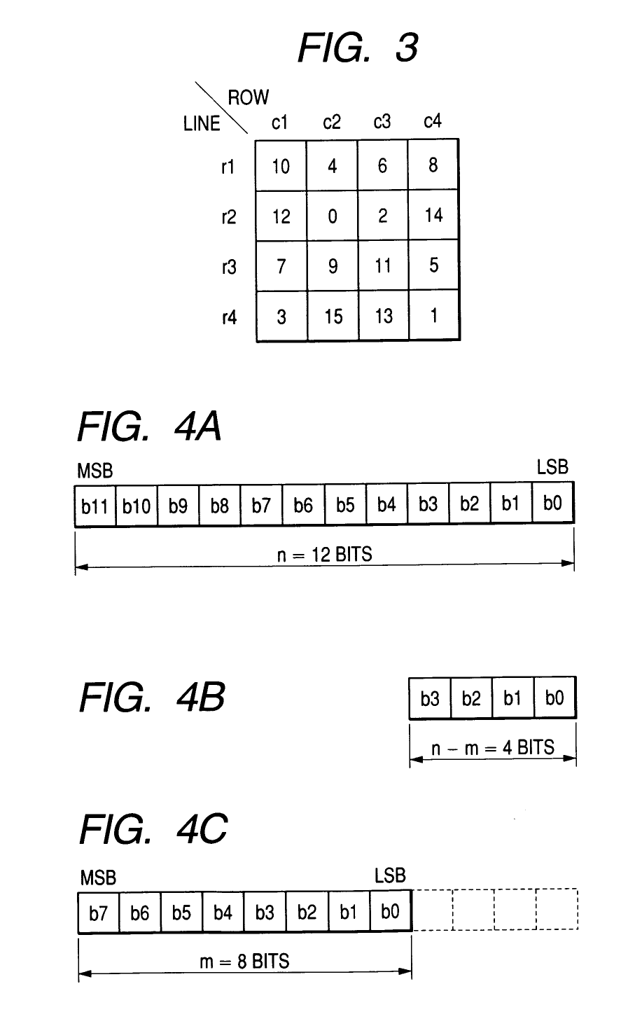

In the dither matrix 12, each dither signal is systematically arranged. FIG. 3 is a view showing an example of the constitution of the dither matrix 12. The matrix 12 is composed with matrix size N=4 of the four rows (c1 to c4)×the four lines (r1 to r4) in order to fit a conversion of input image data of n=12 bits input from the outside to output image data of m=8 bits. Each dither signal is represented by 4 bits, and the dither signals of “0” to “15” are assigned as shown in FIG. 3. This example of the arrangement represents a Bayer matrix which is typical among a large number of matrixes. Of course, the other type matrix may be adopted.

This dither matrix 12 is configured inside a storage device from which the dither signals represented by 4 bits data are successively read out from the storing positions of 4 lines and 4 rows according to the control signal. The storage device can be RAM, programmable ROM or registers.

An adder 13 adds a dither signal of (n−m) bits from the dither matrix 12 to the input image data of n bits supplied from the outside, which is provided to a memory controller 14 as the image data of n bits.

A memory controller 14 deletes a lower (n−m) bits from the input n bits image data added the dither signal so that the n bits image data changes into m bits image data. Then, the memory controller 14 successively stores the m bits image data, from which the lower (n−m) bits were deleted, in the display memory 4.

FIGS. 4A to 4C are views showing a model of the order by which the image data is processed. FIG. 4A shows the input image data of n (=12) bits. FIG. 4B shows the dither signal of (n−m(=4)) bits output from the dither matrix 12. FIG. 4C shows the image data of m (=8) bits, the number of bits of which has been reduced. In FIGS. 4A to 4C, reference mark “bn” simply represents the number of bits, does not represents data.

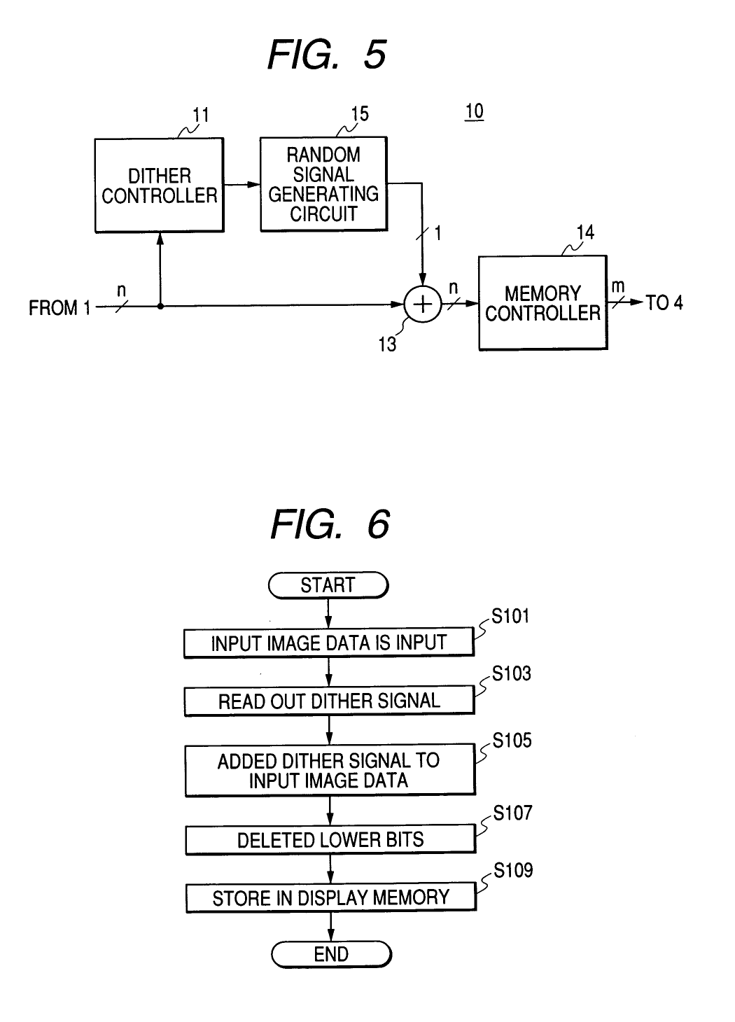

Now, referring to FIG. 6, image conversion processing of the liquid crystal driving device of the first embodiment will be explained in order.

The input image data of n bits is input into the image conversion circuit 10 from the external MPU via the external I/F circuit 1 (S101).

The image conversion circuit 10 successively reads out the dither signal stored in the dither matrix 12 according to the control signal based on the image plane writing start timing signal supplied to the dither controller 11 together with the input image signal or the X address and the Y address showing the pixel position (S103).

When the dither signal is read from the dither matrix 12 of size N, the dither signal of the “i modulo N” th line is successively and repeatedly read out with respect to the data of the i th line of an image and then added to the input image data. In the same manner, the dither signal of “(i+1) modulo N” th line is successively and repeatedly read out with respect to the data of the (i+1)th line of the image. Thereafter, the read dither signal is, as the transmission stream is, added to the input image data. The above “i modulo N” is a method of calculation, which means a remainder obtained when “i” is divided by “N”.

To be specific, in this example, as shown in FIG. 3, since the size N of the dither matrix 12 is 4, the dither signals stored in the dither matrix 12 of the fourth line and the fourth row are successively and repeatedly read out with respect to the input image data of the first line in such a manner that the dither signals of the r1-th line are read out in the order to c1 row (10), c2 row (4), c3 row (6), c4 row (8), c1 row (10). . . . In the same manner, with respect to the input image data of the second line, the dither signals are successively and repeatedly read out in the order of c1 row (12), c2 row (0), c3 row (2), c4 row (14), c1 row (12). . . . With respect to the input image data of the fifth line, which becomes the N+1 line, the dither signals of the r1-th line are read out again in the order to c1 row (10), c2 row (4), c3 row (6), c4 row (8), c1 row (10). . . .

The dither signals of 4 bits (see FIG. 4B.), which have been read out in this way, are added to the input image data (see FIG. 4A.) of 12 bits in the adder 13 (S105). The input image data of 12 bits, to which the dither signals are added, are provided to the memory controller 14. The memory controller 14 deletes the lower 4 bits to be image data of 8 bits subjected to the dither processing as shown by the broken line in FIG. 4C (S107) and stores in the display memory 4 (S109).

As described above, the dither signals from the dither matrix are added to the input image data of n(=12) bits, and then the upper m(=8) bits are stored in the display memory 4. As a result, the image conversion (gradation conversion) using the dither matrix can be performed in real time, as a transmission stream of image data input from the outside is, without increasing a processing load of MPU provided outside the external I/F circuit 1.

The above explanations are made into a case in which the bit length of the input image data of n(=12) bits is reduced to m(=8) bits, wherein the explanations are made by using the dither matrix 12 of N=4, that is, the dither matrix 12 of 4×4. However, the size of the dither matrix 12 can be N=3, that is, 3×3. Alternatively, the size of the dither matrix 12 can be N=2, that is, 2×2. In the case where the size of the dither matrix 12 is N=3 or N=2, the number of bits of the dither signals is 3 bits or 2 bits.

For example, when the dither matrix of N=3, that is, 3×3, is used, the number of bits of the dither signals is set at 3 bits. At this time, the dither signals of 3 bits are used as the upper 3 bits of the dither signals expressed by b3 to b0 shown in FIG. 4B, that is, the dither signals of 3 bits are used as b3, b2 and b1.

Even if the number of bits of the dither signal is reduced as described above, it is possible to provide the substantially same dither-processing effect as that of a case in which the bit length is not reduced. When the number of bits of the dither signal is reduced, RAM, PROM and the register size for the dither matrix can be reduced.

FIG. 5 is a block diagram showing the image conversion circuit 20 of second embodiment. In the second embodiment, the image conversion circuit 20 is provided in the driver controller 5 instead of the image conversion circuit 10 of the first embodiment. The image conversion circuit 20 shown in FIG. 5 uses random dither processing as the dither processing method. In this embodiment, explanations will be made under the conditions that dither processing is performed for the input image data of n(=12) bits so that the number of bits can be reduced to m(=8) and stored in the display memory 4.

The image conversion circuit 20 has a random signal generating circuit 15 instead of the dither matrix 12 in the first embodiment.

The random signal generating circuit 15 receives a starting signal from the dither controller 11 and starts to generate random signals of 1 bit. The random signal generating circuit 15 provides the random signal to the adder 13.

The random signal generating circuit 15 is, for example, M series (maximum period pulse row) generating circuit, in which the shift register and the exclusive OR circuit (EX-OR circuit) are combined with each other and the clock pulses generator is added to it, for generating a pulse train of a specific period. Concerning the pulses generated by the M series generating circuit, the probability of generation of ‘0’ and that of ‘1’ are equal to each other, and the randomness in the period can be guaranteed. Therefore, it is possible to use the pulse generated by the M series generating circuit as a pseudorandom signal.

The adder 13 adds the random signals of 1 bit to the input image data of n bits. The bit position where the random signals are added is the (n−m)th bit, that is, when FIG. 4A is referred, the random signals may be added to the bit of b3 which is the fourth bit from “LSB”.

The memory controller 14 deletes lower (n−m) bits from the input image data of n bits, to which the dither signals are added, to be image data of m bits. Then, the memory controller 14 successively stores the image data of m bits, the number of bits of which is reduced, in the display memory 4.

Concerning the image conversion processing motion of the liquid crystal driving device of this second embodiment, only the dither matrix 12 is changed into the random signal generating circuit 15, and the other constitution is substantially the same as that of the first embodiment, and the motions are substantially the same. Therefore, the explanations are omitted here.

According to this second embodiment, the obtained image quality is inevitably deteriorated, in regard to the image quality obtained, compared with the first embodiment in which the dither matrix is used. However, the more improved image quality can be obtained in comparison with a case that the lower bits are only deleted. Further, the constitution can be made simple.

A bit position where the random signal is added is the (n−m+1)th bit, that is, referring to FIG. 4A, the random signal may be added to b4 bit which is the fifth from LSB. In this case, it is possible to conduct the dither processing in the same manner as that of the second embodiment. Besides, when the data is stored in the display memory 4, the lower bits may be simply deleted without conducting the dither processing, and the dither signal may be added to the lowest bits when the data is read out from the display memory 4.

According to the above explanation, the systematic dither (dither matrix) and the random dither are added to the input image data of plural n bits, and the upper m bits are stored in the display memory 4. Consequently, the image conversion by the dither method can be performed in real time, as a transmission stream of the image data input from the outside is, without increasing a processing load of MPU provided outside the external I/F circuit 1.

What is claimed is:

1. A display unit comprising:
display means;
display memory means, which is connected to the display means, for storing a content to be displayed;
driving means connected to the display means;
image converting means for converting input image data of plural n bits, which are input from an outside via interface means, into image data of plural m (m<n) bits so as to store the image data of plural m bits in the display memory means; and
a controller section for controlling at least one of the display means, the display memory means, the driving means and the image converting means,
wherein the image converting means generates a dither signal or a random signal corresponding to a position of the input image data which is designated by a line and a row on the display memory means, adds the dither signal or the random signal to the input image data, and outputs upper m bits of the image data, to which the dither signal or the random signal was added.

2. A display unit comprising:
a display memory for storing image data for displaying images on a display; and
a dither signal generator for generating a dither signal,
an adder for adding the dither signal to an input image data, and
a memory controller for deleting predetermined lower bits from the input image data, to which the dither signal is added, to store a left input image data, which remains after deleting the predetermined lower bits, in the display memory.

3. The display unit according to claim 2,
the dither signal is systematic dither signal corresponding to a position of the input image data which is designated by a line and a row on the display memory.

4. The display unit according to claim 2,
the dither signal is random signal of 1 bit.

5. A gradation reducing method comprising the steps of:
generating a dither signal;
adding the dither signal to an input image data;
deleting predetermined lower bits from the input image data, to which the dither signal is added; and
storing a left input image data, which remains after deleting the predetermined lower bits, in the display memory.

6. The gradation reducing method according to claim 5,
the dither signal is systematic dither signal corresponding to a position of the input image data which is designated by a line and a row on the display memory.

7. The gradation reducing method according to claim 5,
the dither signal is random signal of 1 bit.
